(19) United States
(12) Patent Application Publication
(10) Pub. No.: US 2020/0383480 A1
(43) Pub. Date: Dec. 10, 2020

(54) CHAIR WITH A SELF-ADJUSTING JOINT

(71) Applicant: AERIS GMBH, Haar bei Munchen (DE)

(72) Inventor: Thomas Hermann SCHROEDER, Beaumont, TX (US)

(73) Assignee: AERIS GMBH, Haar bei Munchen (DE)

(21) Appl. No.: 16/769,472

(22) PCT Filed: Jan. 9, 2019
(86) PCT No.: PCT/EP2019/050450

§ 371 Date: Jun. 3, 2020

Related U.S. Application Data
(60) Provisional application No. 62/615,476, filed on Jan. 10, 2018.

(51) Int. Cl. A47C 3/025; A47C 9/00; A47C 3/026; A47C 7/00; A47C 7/14; F16F 1/393; F16F 3/087

(52) U.S. Cl. CPC A47C 3/0252; A47C 9/002; A47C 3/026; F16F 3/0873; A47C 7/14; F16F 1/3935; A47C 7/004

(57) ABSTRACT

The invention relates to a self-adjusting joint (11) which is designed to receive an end of a chair leg of an active dynamic chair, comprising a hollow inner cylinder (12) that comprises an upper and lower end-face edge (12o, 12u) and a hollow outer cylinder (13) that is arranged around the exterior of the inner cylinder (12) and has an upper and lower end-face edge (130, 13u), each of which is offset relative to the upper and lower end-face edge (12o, 12u) of the inner cylinder (12) in the axial direction (A), and a first compression spring section (11a) that consists of a plurality of cylinder bodies or cylinders (15a) which surround the inner cylinder (12) and between which a respective elastomer section (14a) is arranged so as to connect the cylinder bodies or cylinders, and a second compression spring section (11b) that is arranged at a distance from the first compression spring section in the axial direction (A) and consists of a plurality of cylinder bodies (15b) or cylinders which surround the inner cylinder (12) and between which a respective elastomer section (14b) is arranged so as to connect the cylinder bodies or cylinders.

The present invention relates to a chair with a self-adjusting elastic joint.

There are various seating systems, which can be divided into three sections: a base section (base or support), an intermediate section (e.g. multiple legs), and an upper section (seat or seat part).

Most chairs, stools, or seats traditionally have a rigid connection for the two interfaces between the base, the intermediate section, and the seat. More recent developments have provided a flexible connection for at least one of these interfaces with an associated restoring mechanism.

Such movable or active dynamic chairs differ with respect to static chairs in that a chair user sitting on the chair can perform torso and body movements together with the seat part, which is not possible with static chairs.

Human physiology prefers dynamic movements to static rest when sitting as well. Chairs which at the same time carry the weight of the legs should not just allow dynamic movement but also provide ergonomic support to the seat user.

Seating furniture is in most cases equipped with seating surfaces and backrests designed accordingly in an anatomically maximally favorable position, such that the body, particularly the back, is supported. Such seating furniture is often felt to be comfortable but has the decisive disadvantage that the body just sits passively, that is, the back muscles are rarely placed under stress and the intervertebral disks are subjected to a permanent compressive load. After extended use of these seating devices, this can lead to degeneration of the back muscles and wear on the intervertebral disks. Health problems and pain in the back and hip regions are a frequent consequence of static or passive sitting.

This is why active dynamic seating devices were developed which allow so called active dynamic sitting in which the back muscles and the intervertebral disks are always slightly active. This active dynamic sitting position is achieved in virtually all cases in that the actual seat of the seating device is held in an unstable position and can be moved by a seat user back and forth between a resting position and a laterally deflected position.

Such an active dynamic pendulum chair is known, for example, from DE 42 44 657 02. This document describes a generic type of seating device which consists of a base part, an intermediate piece connected to the base part, and a seat part that is rigidly connected to the intermediate piece, wherein the intermediate piece is kept tiltable into every lateral direction using an elastically deformable connecting member in an opening of the base part and restored to its neutral position (resting position) in an unloaded state.

For example, U.S. Pat. No. 5,921,926 shows an active dynamic pendulum chair, which is also based on the principle of an inverted pendulum. Such chairs have a defined path of movement and a structural restoring mechanism, which at the same time comprise a protective device to prevent the chair from toppling over. However, the seat tilts into a position inclined away from the body center when the pendulum is moved backwards from a horizontal position.

Such pendulum chairs allow swinging the seat back and forth from the undeflected starting position into various deflected positions, whereby the seating surface tilts from its horizontal position into an inclined position. The tilting angle depends on the deflection direction and the degree of deflection. For example, in a pendulum chair in which the horizontally mounted seat is firmly connected to a pendulum column that can be moved back and forth, the seat moves into a clearly inclined position the more the column is deflected from its horizontal position.

EP 0 808 116 B1 describes a pendulum bearing which is disposed between the column and the base part. The pendulum bearing is designed as a rubber-bonded metal and consists of one substantially tubular top part, the top end of which is used for a splined connection, and a bottom part, which is firmly attached to an arm of the base part and an elastic material disposed between the top and bottom parts. The pendulum bearing allows the seat part to swing back and forth. A sitting person can move into every lateral direction by swinging about a point (inclining). The axial load (bearing load) that is applied to such a system depends on the weight of the sitting person and influences lateral movement deflection (tilting load). This concept therefore provides a setting for the stiffness of the flexible connection. While this solution of spring stiffness adjustability can be sufficient in a single user environment, a better solution must be found for a multi-user environment.

Ideally, the stiffness of the flexible joints (particularly for the tilting load) would be a dynamic and self-adjusting function of the user's seated weight.

DE 10 2009 019 880 A1 therefore discloses an item of seating furniture having a seat and a pendulum device for performing pendular movements of the seat with a device for automatic adjustment of the pendulum return force depending on the weight of a person using the seat. This item of seating furniture comprises a seat, a spring strut, a base, and a pendulum device as well as a device for automatic adjustment of the pendulum return force. This item of seating furniture is configured such that the lever arm in a bottom bearing of the center column is extended if the spring strut carrying the seat sinks in deeper due to a higher body weight of a user, whereby the resistance to lateral deflection increases as the seat user's body weight increases.

As can also be derived from DE 10 2009 019 880 A1, the device has a complex structure. A bearing housing, a plurality of rubber bearings disposed in the holder, a control element that can be moved along the rubber bearings, and an upper radially circumferential rubber seal are used to close the device towards the outside. Furthermore, the device comprises a coil spring on which the control element rests. The penetration depth of the control element into the bearing housing results from the body weight of the seat user and the spring constant of the coil spring.

It is a disadvantage of this restoring device that it uses a coil-type (compression) spring as means for regulating the penetration depth and that his means predominantly produces a restoring force in the axial direction. Various bending moments result as a function of the penetration depth, and the coil spring which is to be operated axially is twisted accordingly. Furthermore, the restoring device has a complex structure, and its properties are determined by the interaction of the various components that can be moved relative to each other. Mechanical abrasion may also occur due to the relative movement between the control element and the rubber bearings.

Starting from this device, it is the problem of the present invention to provide an alternative restoring device for automatic adjustment of the return force, which device is less complex in structure and overcomes the disadvantages mentioned and allows complex motion dynamics of the seat part.

This is because it is desirable for dynamic movements of a sitting person, that said person can move his or her entire body including his or her torso similar to moving with a hula hoop, and in this process to perform both pendular movements “as such” and “lateral” deflections (i.e. horizontal translational movements) with his or her pelvis to compensate for weight shifts of the upper regions such as the arms and the head, and to set these regions into motion. It is also desirable in this context that the front seat part does not go down as usual during a forward movement in the forward direction, and that the rear seat part is not go down as usual during a rearward movement in the rearward direction, but that instead performs a motion curve similar to the movement of a seat of a swing.

Based on prior art, the problem underlying the present invention therefore is to overcome the disadvantages mentioned and to provide an active dynamic chair in which a seat user can perform safe and manifold movements of the seat part in a defined moving space. Advantageously, the chair is to allow a chair user to perform horizontal translational movements of the seat area, and the change in seat inclination is to take place in accordance with the chair user's ergonomic needs.

The invention is thus based on the concept of a self-adjusting joint, including an inner cylinder having an upper and a lower end-face edge and an outer cylinder arranged around the exterior of the inner cylinder (having a greater diameter), likewise having an upper and lower end-face edge, wherein said edges are offset relative to the upper and lower end-face edge of the inner cylinder in the axial direction, as well as an first (elastically deformable) compression spring section that consists of a plurality of cylinder bodies which surround the inner cylinder and between which a respective elastomer section is arranged so as to connect the cylinder bodies and a second compression spring section that is arranged at a distance from the first compression spring section in the axial direction and consists of a plurality of cylinder bodies which surround the inner cylinder and between which a respective elastomer section is arranged so as to connect the cylinder bodies.

Furthermore, multiple secondary problems and advantages of the present invention include providing a motion joint and particularly a chair having such a joint, which chair:

(a) provides sufficient axial (vertical) deflection to allow “attenuation”

(b) allows a tilting movement;

(c) provides increased tilt stiffness as a function of an increased axial load;

(d) allows limited torsion;

(e) provides a restoring mechanism for tilt, torsion, and axial load;

(f) allows uniform movement;

(g) is user-friendly and safe.

These problems are solved by the measures described in the coordinate independent claims. Advantageous embodiments of the invention are described in the respective dependent claims.

In a special embodiment of the invention, the first elastomer sections between the first cylinder bodies are formed separately from the second elastomer sections of the second cylinder bodies and that a hollow space is formed between the respective elastomer sections (when viewed in the axial direction).

Advantageously, the multiple cylinder bodies are arranged to each other like onion skins, and said elastomer bodies are located between the respective cylinders.

It is further advantageous that an end-face edge of the respective cylinder bodies located farther outwards is arranged at an offset in the axial direction relative to the end-face edge on the same side of the cylinder bodies located farther inwards.

It is further advantageous that the cylinder bodies of the first compression spring section are formed separately from the cylinder bodies of the second compression spring section.

Also advantageous is a design in which the cylinder body of the first compression spring section is connected to the cylinder body of the second compression spring section or the cylinder bodies are formed integrally in one piece as joint cylinder bodies.

In another advantageous embodiment, a hollow space is formed between the upper and lower elastomer sections, which is filled with a gaseous medium, air, or an elastomer having a significantly lower Shore hardness than the elastomer in the elastomer section.

Another aspect of the present invention relates to an active dynamic chair having a base, at least one chair leg, and a seat mounted to the top end of the chair leg, wherein at least the bottom end of the chair leg is fastened in a self-adjusting joint as described, which joint is located on the base.

Other problems and advantages are illustrated by the description below and the drawings.

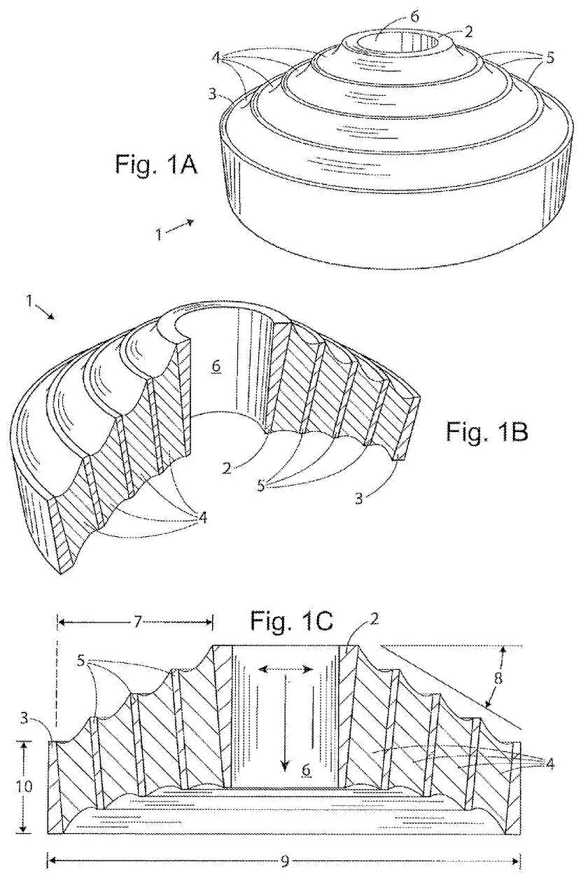

FIG. 1a is a perspective view of a known elastic conical compression joint.

FIG. 1b is a sectional perspective view of FIG. 1a.

FIG. 1c is an orthogonal cross sectional front view of FIG. 1a.

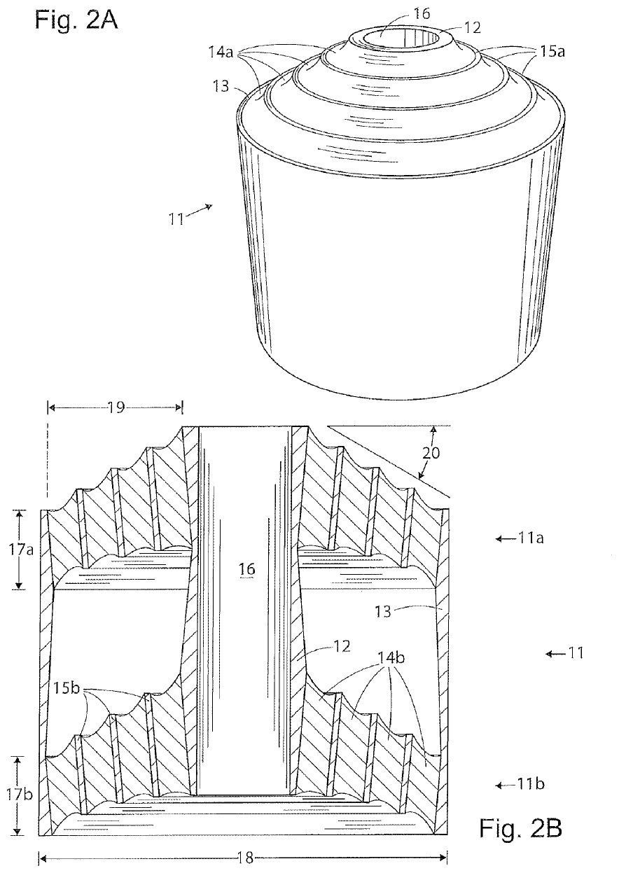

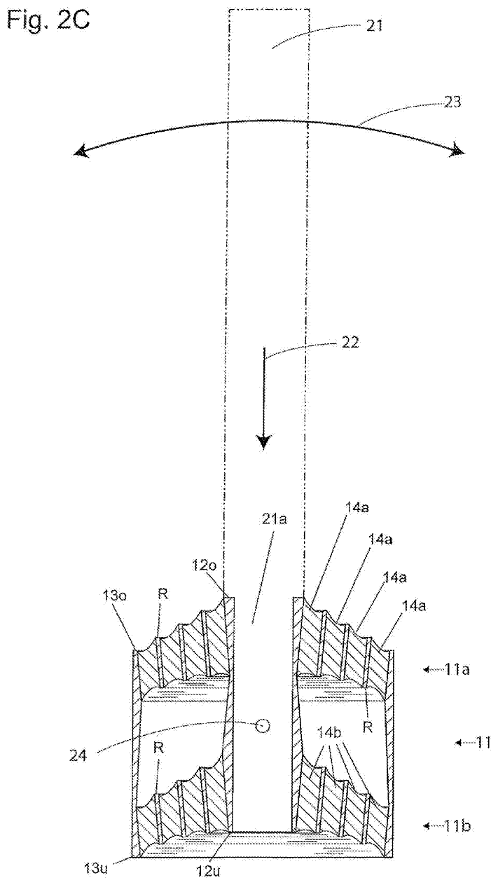

FIG. 2a is a perspective view of a first embodiment of a self-adjusting motion joint according to the concept of the present invention.

FIG. 2b is an orthogonal sectional view of FIG. 2a.

FIG. 2c is a cutaway front view of the connection of 2a, which is connected to a support member of a chair.

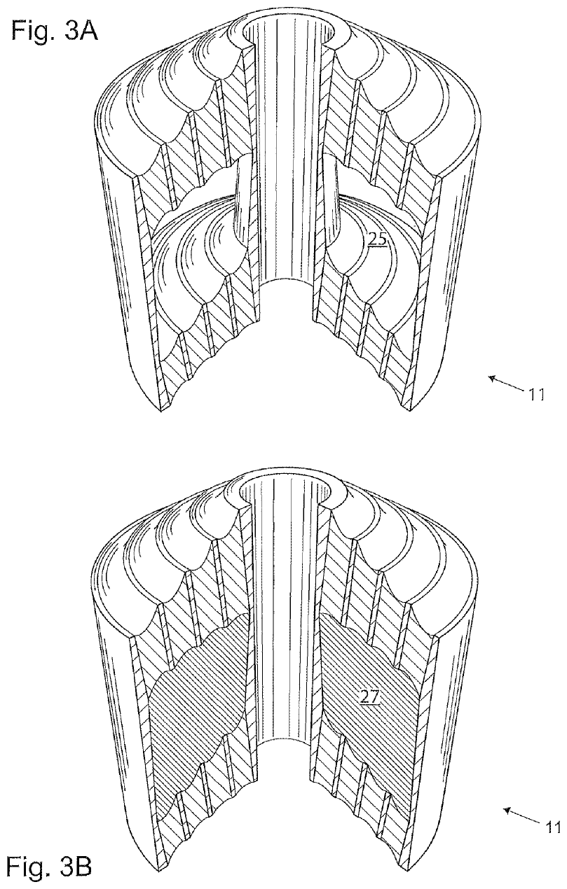

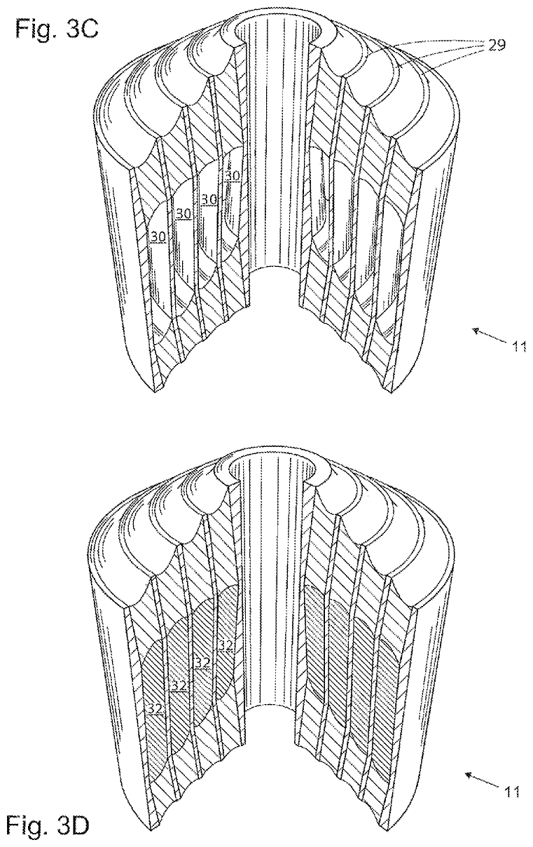

FIG. 3a is a sectional perspective view of FIG. 2a.

FIG. 3b is a sectional perspective view of a second embodiment of FIG. 2a.

FIG. 3c is a sectional perspective view of a third embodiment of FIG. 2a.

FIG. 3d is a sectional perspective view of a fourth embodiment of FIG. 2a.

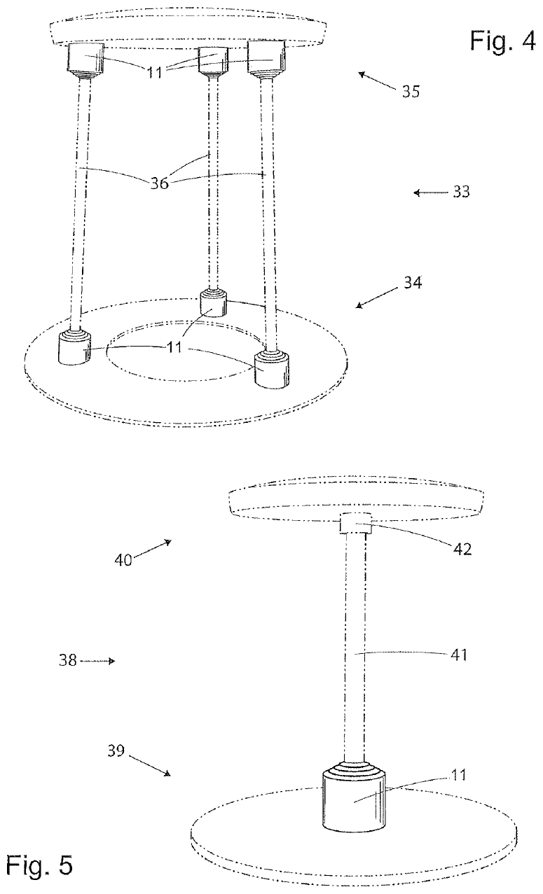

FIG. 4 is a perspective view of an active dynamic chair using 6 self-adjusting joints.

FIG. 5 is a perspective view of an active dynamic chair or stool which uses a single self-adjusting motion joint on its base.

The invention is described in more detail below with reference to FIGS. 2 to 5, wherein the same reference symbols indicate same structural and/or functional features.

FIGS. 1a to 1c show an elastomeric joint 1 known from prior art. It has a hollow tubular inner cylinder 2 and an outer cylinder 3. The inner cylinder 2 provides a receiving space 6. The outer cylinder 3 is typically connected to, or configured with, a support base not shown in detail herein. Both cylinder bodies 2 and 3 are interconnected by an elastomer section 4 and an optional number of rigid cylinder bodies 5.

FIG. 1c clearly shows the conical gradation of the multiple elastic sections 4. If an axial load (see axial arrow) is transferred into the hollow space 6 via a connecting member, the taper angle 8 is reduced and the elastomer section 4 is compressed and partially sheared off.

FIGS. 2a to 2c show a self-adjusting joint 11 according to the concept of the present invention. FIG. 2b and FIG. 2c show a two-part construction of two conically graded compression spring sections 11a and 11b (shown herein as identical for the sake of simplicity).

The inner tubular cylinder body 12 (hollow cylinder with a round cross sectional area) provides a receiving space for a chair leg and has a substantially cylindrical inner wall with an inner diameter which remains constant between the top compression spring section 11a and the bottom compression spring section 11b.

As is clearly apparent from the figures, the inner cylinder 12 has a wall of different wall thicknesses, wherein the wall thickness initially decreases in the embodiments according to FIGS. 2B, 2C, 3A, and 3B from an upper end 12o until the top compression spring section 11a ends in the vertical direction where it is fastened to the inner cylinder 12.

A hollow space 25 is located between the top compression spring section 11a and the bottom compression spring section 11b, which space is either filled with a medium such as air or with an elastomer 27 as shown in FIG. 3B.

The self-adjusting joint 11 further comprises an outer cylinder 13 (formed of a rigid material). The rigid inner cylinder 11 and the rigid outer cylinder 13 are interconnected, respectively, by two parts, i.e. spatially separated top and bottom elastomer sections 14a and 14b.

The elastomer sections 14a and 14b are each further divided by rigid hollow tubular cylinder bodies 15a and 15b, which are arranged like onion skins relative to each other. Therefore the cylinder bodies 15a, 15b located farther inwards have a smaller diameter than the cylinder bodies 15a, 15b located farther outwards. In a preferred embodiment of the invention, the radial distances of the respective hollow cylinder bodies 15a or hollow cylinder bodies 15b are about the same, such that an approximately equidistant arrangement of cylinder bodies results when viewed in the radial direction. One elastomer is annularly inserted between each of the adjacent cylinder bodies 15a and 15b. When viewed in the radial direction with respect to the central axis through the inner cylinder 11, the upper and lower edges R of the cylinder bodies 15a or 15b located farther outwards are arranged at an offset in the vertical direction with respect to the cylinder bodies 15a or 15b located farther inwards in the representation, such that the joint 11 has an outwardly conically downward sloping lid structure, which in the normal state (i.e. without a force being applied via a chair leg 21) defines a tangential plane through the upper edges of the cylinder bodies 15a or 15b, respectively, which plane is tilted by the tangential angle 20 with respect to a horizontal plane.

The conical compression spring sections 11a and 11b have a height 17a and 17b, respectively, (which can be same or different depending on the desired spring characteristic), a width 19, and a diameter 22.

As is further well apparent in the figures, the inner cylinder 12 has a wall with increasing wall thickness in the axial direction in the region between the top and bottom compression spring sections 11a, 11b, namely where these are connected to the inner cylinder 12.

The wall thickness then decreases again in the region of the bottom compression spring section 11b.

FIG. 2c shows the joint 11 with an elongate support member 21 (here, a chair leg), the connection area 21a of which is non-positively and positively locked in the receiving space 16. If a transverse force is applied to the upper part of the support member 21, as indicated by the double arrow 23, the pivot point 24 (defined between the top and bottom spring sections 11a and 11b) is formed and a tilting movement of the support member 21 is performed.

Since the support member 21 is mounted in two bearing areas (an area between the top scoring section 11a on the one hand and an area between the bottom spring section 11b on the other), the support member 21 can be tilted.

If an additional axial load 22 is applied to the support member 21, the compression spring sections 11a and 11b are partially lowered and thereby laterally compressed and vertically sheared in relation to each other, whereby the tilt stiffness of the support member 21 is automatically increased without the seat user having to adjust the characteristic manually to his or her weight.

All dimensional and material parameters determined may be used to adjust the characteristic of the self-adjusting motion joint 11. For example, an elastomer with a higher hardness may be used to achieve a higher overall stiffness of the joint.

The number of the rigid cylinder bodies 15a, 15b may also be increased to increase tilt stiffness without impairing axial attenuation. An increased height of each spring section increases both inclination and axial stiffness. An increased width of each spring section reduces axial stiffness. An increased distance between the spring sections increases tilt stiffness but does not impair axial stiffness.

This last point indicates the reason for a two-part design of the self-adjusting motion joint: While the height of a spring section increases both inclination and axial stiffness, the distance between the spring sections only increases the inclination of the slope but not the axial stiffness.

FIG. 3a is a sectional perspective view of the joint 11, which is shown here for reference to illustrate alternative embodiments. The space 25 between the top and bottom compression spring sections is filled with air.

FIG. 3b shows a similar self-adjusting motion joint 11, wherein the space between its top and bottom compression spring sections is filled with an elastomer 27 of low hardness.

FIG. 3c shows another self-adjusting joint 11 with a harmonized group of rigid tubular and hollow cylinder bodies 29, which connect the top and bottom compression spring sections to each other. The respective space 30 between the top and bottom compression spring sections 11a, 11 b is configured as a hollow space. The height of the cylinder bodies 29 decreases in this embodiment viewed from the inside to the outside.

In FIG. 3d, these hollow spaces 30 are filled with an elastomer 32 of sufficiently low hardness.

FIG. 4 shows an active dynamic chair 33 having a base 34 and seat 35 which are by three legs 36 to each other using 6 self-adjusting joints 11 (as described above). Each of the self-adjusting joints 37 allows a respective tilt, torsion, and axial load (depending on the weight of the seat user). FIG. 5 shows a pendulum stool 38 having a base 39 and a seat 40, both connected to each other by a single leg 41. The seat 40 has a rigid connection 42 with the chair leg 41. The base 39 is provided with a self-adjusting elastic joint 11 to allow pendular movement of the leg 41 and thus of the seat 40.

As is apparent from FIGS. 4 and 5, the lower edge R of the outer cylinder 13 of the respective joint 11 is mounted onto the base 34 or 39, respectively, and fastened there. Also conceivable is an embodiment in which the lower edge 13u of the outer cylinder 13 is formed axially opposite the connecting section to the bottom compression spring section 15b, such that the center of the joint 11 can dive deeper for seat users with a high body weight before the lower edge 112u of the inner cylinder comes to rest on the base 34 or 39, respectively.

A cylindrical adapter element would be conceivable which is mounted as a spacer to the bottom side of the joint 11.

### LIST OF REFERENCE NUMERALS

1. Elastomeric joint from prior art
2. Inner cylinder (configured as a hollow cylinder)
3. Outer cylinder (configured as a hollow cylinder)
4. Elastomeric intermediate areas
5. Rigid intermediate cylinder bodies
6. Receiving space
7. Width of the elastic area formed of elastomeric intermediate areas
8. Taper angle
9. Diameter of the elastomeric joint
10. Height of the elastomeric joint in the region of the outer flange
11. Self-adjusting joint with conically offset compression spring sections 11a and 11b
12. Inner cylinder
12o Upper edge of the inner cylinder
12u Lower edge of the inner cylinder
13. Outer cylinder
13o Upper edge of the inner cylinder
13u Lower edge of the inner cylinder
14a Elastomer sections
14b Elastomer section
17a,b Height of the tapering compression spring sections 11a,11b
18. Diameter
19. Width
20. Taper angle
21. Elongate support member of a chair
22. Axial load applied via the support member 21 to the joint 11
23. Torque applied to the support member 21
24. Pivot point for the tilting movement of the support member 21
25. Hollow space/intermediate space between the top and bottom compression spring sections 11a and 11b
27. Elastomer Cylinder body
30. Hollow spaces
32. Hollow spaces filled with elastomer
33. Active dynamic chair
34. Base of the chair
35. Seat of the chair
36. Legs of the chair
38. Pendulum stool
39. Base of the stool
40. Seat of the stool
41. Legs of the stool
42. Connection

1. A self-adjusting joint which is designed to receive an end of a chair leg of an active dynamic chair, comprising a hollow inner cylinder that comprises an upper and lower end-face edge, and a hollow outer cylinder that is arranged around the exterior of the inner cylinder and has an upper and lower end-face edge, each of which is offset relative to the upper and lower end-face edge of the inner cylinder in the axial direction (A), and a first compression spring section that consists of a plurality of cylinder bodies or cylinders which surround the inner cylinder and between which a respective elastomer section is arranged so as to connect the cylinder bodies or cylinders, and a second compression spring section that is arranged at a distance from the first compression spring section in the axial direction (A) and consists of a plurality of cylinder bodies or cylinders which surround the inner cylinder and between which a respective elastomer section is arranged so as to connect the cylinder bodies or cylinders.

2. The self-adjusting joint according to claim 1, wherein the first elastomer sections between the first cylinder bodies are formed separately from the second elastomer sections of the second cylinder bodies and that a hollow space is formed between the respective elastomer sections.

3. The self-adjusting joint according to claim 1, wherein the multiple cylinder bodies are arranged like onion skins relative to each other.

4. The self-adjusting joint according to claim 3, wherein the end-face edge (R) of the respective cylinder bodies located farther outwards is arranged offset in the axial direction (A) relative to the end-face edge (R) on the same side of the cylinder bodies located farther inwards.

5. The self-adjusting joint according to claim 1, wherein the cylinder bodies of the first compression spring section are formed separately from the cylinder bodies of the second compression spring section.

6. The self-adjusting joint according to claim 1, wherein the cylinder bodies of the first compression spring section are connected to, or formed integrally with, the cylinder bodies of the second compression spring section as joint cylinder bodies.

7. The self-adjusting joint according to claim 1, wherein the inner cylinder has a wall with different wall thicknesses in the axial direction (A).

8. The self-adjusting joint according to claim 1, wherein a hollow space is formed between the upper and lower elastomer sections, which space is filled with a gaseous medium, air, or an elastomer having a significantly lower Shore hardness than the elastomer in the elastomer section.

9. The self-adjusting joint according to claim 1, wherein the inner cylinder comprises a receiving space for receiving a receiving section of a chair leg.

10. An active dynamic chair having a base, at least one chair leg, and a seat which is mounted to the top end of the chair leg, wherein the bottom end of the chair leg is secured in a self-adjusting joint according to claim 1, which joint is located on the base.

11. The active dynamic chair according to claim 10, wherein three chair legs are provided between the base and the seat part and the bottom ends of the chair legs are each connected to the base at said self-adjusting joint, which joint is provided on the base.
